(19) United States
(12) Patent Application Publication
(10) Pub. No.: US 2006/0110705 A1
(43) Pub. Date: May 25, 2006

(54) Accessible dental bite block

(76) Inventors: Steven Dee Jensen, South Jordan, UT (US); Shaneen Wintch, Taylorsville, UT (US)

Correspondence Address: Steven Jensen, 1190 W. Chavez Dr., South Jordan, UT, 84095, US

(21) Appl. No.: 10/992,567

(22) Filed: Nov. 19, 2004

(51) Int. Cl. A61C 5/00

(52) U.S. Cl. 433/140

(57) ABSTRACT

A dental bite block that is V-shaped. The V-shape provides accessibility to working instruments while in a patients mouth. Current bite blocks are often shaped as solid triangles that are designed to keep the mouth open. A bite block is usually placed by dentists in the side opposite their work area. This provides an open work area for the dentist on one side, but restricts access by dental assistants on the other. The device provides an open V-shaped design that is accessible to dental instruments while maintaining the patients mouth open.

### CROSS REFERENCE TO RELATED APPLICATIONS

U.S. Patent Documents

U.S. Pat. No. 6,652,276 November 2003 Fischer, et al.
U.S. Pat. No. 5,827,061 October 1998 Goodman
U.S. Pat. No. 6,716,029 April 2004 Fischer, et al.
U.S. Pat. No. 6,196,840 March 2001 Zentz, et al.
U.S. Pat. No. 6,540,399 April 2003 Eppinger, et al.
U.S. Pat. No. 6,343,875 February 2002 Eppinger, et al.
D397,442 August 1998 Kittelsen
D297,665 September 1998 Neeley

### STATEMENT REGARDING FEDERALLY SPONSORED RESEARCH AND DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

The mouth is a confined cavity of finite space. A dentist must routinely work within this small confined cavity. There is an inherent difficulty associated with practicing dentistry in the limited space of the oral cavity. There is also an inherent difficulty associated with patients who must maintain their mouths open while the dentist is working. The need to maximize and maintain the oral working area brought about the invention of the bite block. A bite block is a device that is designed to wedge the mouth open during dental treatments.

Bite blocks of the current market encompass basically the triangle wedge designs. The triangle wedge is usually a solid rubber block that is triangular shaped. This solid triangular piece of rubber is designed to be wedged into one side of the patients teeth during dental treatment. A triangular bite block when placed, provides an open work area with good access on one side of the mouth. For this reason, dentists place the triangular wedge on the side of the mouth opposite the area they need to work. This creates a problem for anyone assisting the dentist, the triangular wedge provides excellent access and working area on one side while severely blocking the opposing side.

During routine dental treatments a patient is usually confined in a reclined dental chair. When a reclined patient's mouth is propped open a constant pool of saliva begins to collect at the back of the throat. It is difficult for patients to remove this pool of saliva because it is hard to swallow when ones mouth is open. Therfore it is routine for the dental assistant to remove this excess saliva with an aspirator. The tip of the aspirator must travel to the back of the throat in order extract this saliva. A solid triangular bite block presents an obstacle that the aspirator must navigate around before it can perform its function. Often the dentist habitually vacates the working area in order to provide the assistant access room to aspirate the excess saliva. The open mouth is restricted enough as it is and a wedged triangular bite block further restricts or blocks this space. It creates a one person working environment at a time.

What is needed is a bite block that is designed to allow access of dental instruments to the entire mouth while maintaining the mouth open.

### BRIEF SUMMARY OF THE INVENTION

Present invention provides a device that allows access of dental instruments through a notch in a V-shaped bite block while maintaining the mouth open. Dental instruments are able to gain access to the working area through the open notch of the V-shaped design. This allows dental assistants to assist the dentist without having the dentist vacate the mouth each time the dental assistant performs various functions.

### BRIEF DESCRIPTION OF THE SEVERAL VIEWS OF THE DRAWING

FIGS. 1A, B and C are front, back and side view drawings of a bite block that is substantially V-shaped.

FIGS. 2A, B and C are front, back and side view drawings of a bite block that is substantially V-shaped.

FIGS. 3A, B and C are front, back and side view drawings of a bite block that is substantially V-shaped.

FIGS. 4A and B are top and side view drawings of a prior art bite block that is solid triangular shaped.

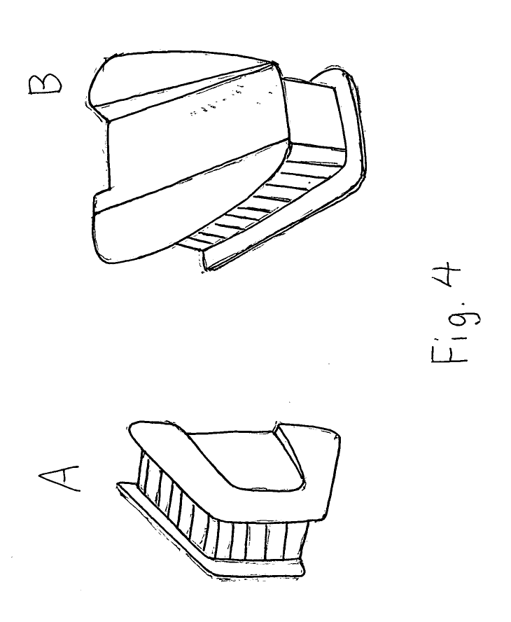

### DETAILED DESCRIPTION OF THE INVENTION

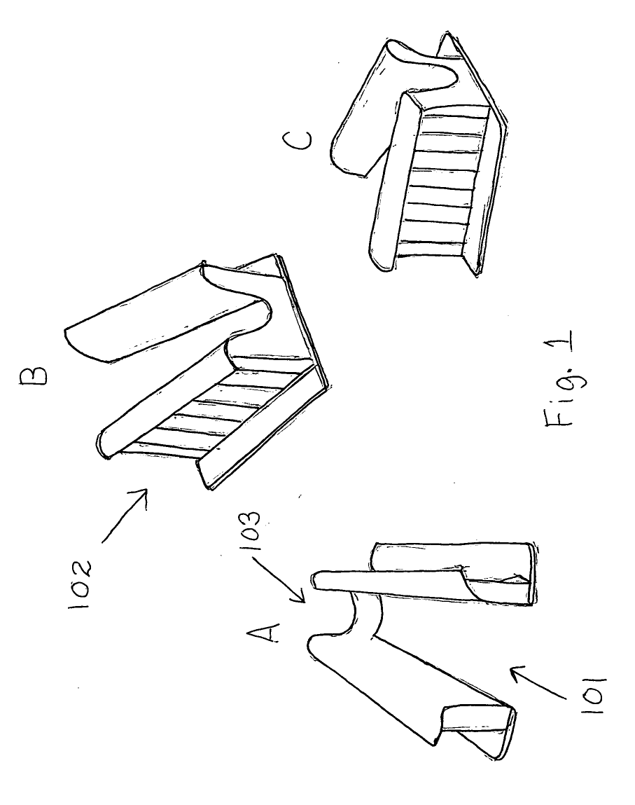

Preferred embodiments of the present invention can be described by reference to the figures. A substantially V-shaped example of an embodiment is found in FIG. 1. This device is designed such that it can be wedged in a patients mouth maintaining the mouth open. The notch opening 101 is the access path whereby dental instruments gain oral access while in a patients mouth. The biting surface can be designed with friction ribs 102 to prevent the bite block from slipping out while biting down. The device of FIG. 1 particularly provides excellent access to the back of the throat because it effectively maximizes access space by the use of a solitary arched slender rail 103.

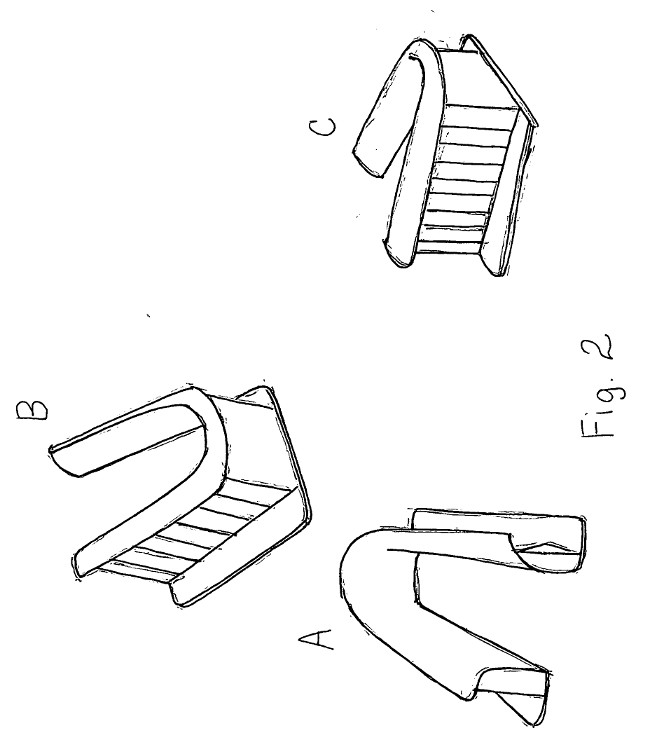

Another substantially V-shaped example of an embodiment is found in FIG. 2. While not as accessible as FIG. 1, this bite block provides an opening notch sufficient for excellent access by dental instruments.

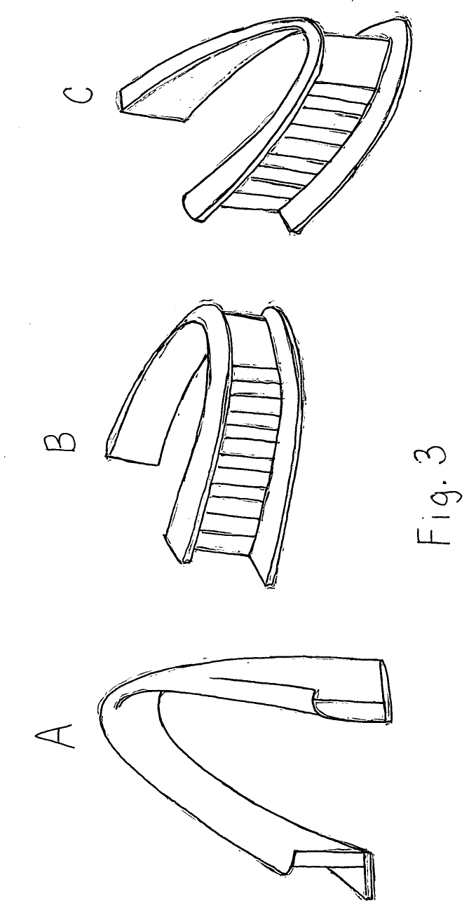

Another substantially V-shaped example of an embodiment is found in FIG. 3. This design adds a slight arch to the V-shape allowing a more general open access to the back of the mouth.

A method of constructing the device is by first creating a rigid endoskeleton in the shape of the device, followed by coating the device in an elastomer such as rubber. The endoskeleton can be made from materials such as machined metals, die cast metals, rigid plastics or any material that can be formed into a rigid structure. Another method of construction is to make or mold the entire device from a semi-rigid material that is not sufficiently hard as to damage the teeth, yet is strong and rigid enough to withstand the biting forces of the mouth.

1. A dental block comprising:
a. two support arms of uniform width each having dental contact means;
b. a bridging means of width narrower than the support arms, spanning interior ends of said support arms and holding them at an acute interior angle relative to each other.

2. The dental block of claim 1, the bridging means comprising a solitary rail of significant tensile strength.

3. The dental block of claim 2, the rail positioned at an extreme exterior edge of the support arms.

4. The dental block of claim 3, further comprising a rigid endoskeleton enveloped in an elastomer.

5. The dental block of claim 1, further comprising a rigid endoskeleton enveloped in an elastomer.

6. The dental block of claim 1, the support arms further comprising an arched relationship opposite each other.

7. The dental block of claim 6, the bridging means comprising a solitary rail of significant tensile strength.

8. The dental block of claim 7, the rail positioned at an extreme exterior edge of the support arms.

9. The dental block of claim 8, further comprising a rigid endoskeleton enveloped in an elastomer.

10. The dental block of claim 6, further comprising a rigid endoskeleton enveloped in an elastomer.

11. The dental block of claim 1, the dental contact means further comprising a series of friction ribs.

12. The dental block of claim 11, the bridging means comprising a solitary rail of significant tensile strength.

13. The dental block of claim 12, the rail positioned at an extreme exterior edge of the support arms.

14. The dental block of claim 13, further comprising a rigid endoskeleton enveloped in an elastomer.

15. The dental block of claim 11, further comprising a rigid endoskeleton enveloped in an elastomer.
